(19) United States
(12) Patent Application Publication
(10) Pub. No.: US 2023/0126848 A1
(43) Pub. Date: Apr. 27, 2023

(54) PROCESS FOR DETECTION OF EVENTS OR ELEMENTS IN PHYSICAL SIGNALS BY IMPLEMENTING AN ARTIFICIAL NEURON NETWORK

(71) Applicant: STMicroelectronics (Rousset) SAS, Rousset (FR)

(72) Inventors: Pierre Demaj, Nice (FR); Laurent Folliot, Gourdon (FR)

(21) Appl. No.: 17/968,174

(22) Filed: Oct. 18, 2022

(30) Foreign Application Priority Data
Oct. 25, 2021 (FR) 2111299

(51) Int. Cl. G06N 3/04

(52) U.S. Cl. CPC G06N 3/0472

(57) ABSTRACT

According to one aspect, a method is provided for detecting events or elements in physical signals, including at least one implementation of a reference artificial neural network, at least one implementation of an auxiliary artificial neural network distinct from the reference artificial neural network. The auxiliary artificial neural network being simplified relative to the reference artificial neural network. At least one assessment of a probability of presence of the event or the element by the implementation of the reference artificial neural network or by the implementation of the auxiliary artificial neural network, where the reference artificial neural network is implemented when the probability of presence of the event or the element is greater than a threshold, and wherein the auxiliary artificial neural network is implemented when the probability of presence of the event or the element is below the threshold.

### CROSS-REFERENCE TO RELATED APPLICATIONS

This application claims priority to French Patent Application No. 2111299, filed on Oct. 25, 2021, which application is hereby incorporated by reference herein in its entirety.

### TECHNICAL FIELD

The present disclosure generally relates to artificial neural networks, and in particular embodiments, to an artificial neural network configured to detect events or elements in physical signals.

### BACKGROUND

Generally, artificial neural networks can be used to detect events or elements in physical signals received at the input of these neural networks. For example, artificial neural networks can take images as input and are used to detect events or elements in these images, in particular, to detect objects or people.

The execution of a neural network can involve a significant amount of calculations. However, the greater the number of calculations, the higher the energy consumption resulting from executing the artificial neural network. The energy consumption resulting from the execution of a neural network depends on the execution time of the artificial neural network, which is linked to the complexity of this neural network.

In some applications, neural networks can be implemented by microcontrollers having limited energy autonomy. Indeed, the microcontrollers may not be powered directly by an electrical distribution network, but may be powered by an autonomous battery having a limited energy storage capacity. For example, the artificial neural networks can be implemented by microcontrollers integrated into connected objects, including batteries to power these microcontrollers.

It is particularly important in these applications to reduce the energy consumption of the microcontroller implementing the artificial neural network to increase the service life of the battery, such that the microcontroller can be used as long as possible before recharging the battery or even replacing the device, including the microcontroller, which is impractical and expensive.

It is possible to stop using the artificial neural network during certain periods to reduce the power consumption of the microcontroller. Nevertheless, such a solution has the drawback of not allowing detecting events or elements in the physical signals received as input during these periods.

It is also possible to simplify the artificial neural network to reduce the calculations performed during the execution of the simplified neural network. For example, quantifying a neural network allows simplifying it. Nevertheless, the simplified neural networks can lead to a loss of performance of the artificial neural network to detect the events or the elements in the physical signals received as input of this neural network.

It is, therefore, advantageous to propose a solution for reducing the energy consumption of a microcontroller implementing a neural network adapted to detect events or elements while maintaining good detection performance.

### SUMMARY

According to one aspect, a method is proposed for detecting events or elements in physical signals, including at least one implementation of a reference artificial neural network, at least one implementation of an auxiliary artificial neural network distinct from the reference artificial neural network, the auxiliary artificial neural network being simplified relative to the reference artificial neural network, at least one assessment of a probability of presence of the event or the element by the implementation of the reference artificial neural network or by the implementation of the auxiliary artificial neural network, in which the reference artificial neural network is implemented when the probability of presence of the event or the element is greater than a threshold, and in which the auxiliary artificial neural network is implemented when the probability of presence of the event or the element is below the threshold.

The reference artificial neural network and the auxiliary artificial neural network can be implemented by a microcontroller supplied with energy by a battery.

The energy consumption resulting from the implementation of a neural network varies depending on the amount of calculations to be performed before generating data as output of the artificial neural network. In particular, the more the number of calculations is limited, the more the energy consumption resulting from the implementation of the artificial neural network is reduced. Thus, in a method according to the invention, the implementation of the auxiliary artificial neural network when the probability of the presence of the event or the element is lower than the threshold allows reducing the energy consumption resulting from the implementation of the detection method.

Indeed, the auxiliary artificial neural network is a simpler and faster network than the reference artificial neural network. The execution of the auxiliary artificial neural network, therefore, requires fewer calculations to be performed than the execution of the reference artificial neural network. The auxiliary artificial neural network is therefore configured to generate output data more quickly from a physical signal received as input relative to the reference artificial neural network receiving this same physical signal as input. Of course, the data generated as output of the auxiliary artificial neural network are not necessarily identical to those which can be generated as output of the reference artificial neural network. The person skilled in the art will know how to define a simplified neural network relative to the reference artificial neural network.

In particular, the auxiliary artificial neural network is distinct from the reference artificial neural network. The auxiliary artificial neural network may have a different topology from the reference artificial neural network. More particularly, the auxiliary artificial neural network can have weights which are different from the weights of the reference artificial neural network. The auxiliary artificial neural network can be designed from the reference artificial neural network, for example, by removing some neurons from the reference artificial neural network. The performance of the auxiliary artificial neural network can be assessed by simulation.

This auxiliary neural network may be slightly less efficient than the reference artificial neural network. Nevertheless, the reduced performance of the auxiliary artificial neural network is compensated by the implementation of the reference artificial neural network when the probability of the presence of the event or element determined by the auxiliary artificial neural network is greater than the threshold. Indeed, the auxiliary artificial neural network is implemented only when this probability of presence is below a threshold.

The execution of the auxiliary artificial neural network, therefore, allows maintaining a monitoring of the presence or absence of an event or an element while reducing the energy consumption. In this manner, it is possible to increase the time of autonomy of a battery powering the microcontroller implementing the artificial neural network. The assessment of the probability of presence of the event or the element is performed regularly after one or more implementations of the reference artificial neural network or the auxiliary artificial neural network.

Such a method is relatively simple to implement.

In one advantageous embodiment, the reference artificial neural network and the auxiliary artificial neural network are configured to be able to delimit the event or the element to be detected in the physical signal.

Alternatively, the reference artificial neural network can be configured to be able to delimit the event or the element to be detected in the physical signal, and the auxiliary artificial neural network can be configured to be able to identify (i.e., classify) a presence of the event or the element to be detected in the physical signal.

Such an auxiliary neural network is then simpler than a neural network capable of delimiting an event or an element to be detected in a physical signal.

Such an auxiliary neural network, therefore, consumes little energy.

The identification of the presence of an event or an element in the physical signal allows for simplifying the detection of the event or the element by the auxiliary artificial neural network relative to the reference artificial neural network.

Once the event or the element is identified in the physical signal, the reference artificial neural network can be implemented to delimit the event or the element, to perform tracking of the event or the element in the physical signal.

In this manner, the method allows for maintaining good monitoring performance.

In an embodiment, when the physical signal is an image and an attempt is made to detect an object or a person in the image, the auxiliary artificial neural network is configured to identify that the object or a person is present in the image. The reference artificial neural network is configured to delimit the object or the person in the image, in particular, to perform tracking of the position of the object or the person in a succession of images.

Preferably, the threshold is defined according to the artificial neural network's sensitivity or desired accuracy.

In embodiments, the reference artificial neural network and the auxiliary artificial neural network are stored in a non-volatile memory, in particular, a flash memory. The reference artificial neural network can be quantized on 8 bits to be accurate and have good performance. Advantageously, the auxiliary artificial neural network is quantized at most on 8 bits. Preferably, the auxiliary artificial neural network is quantized on less than 8 bits. This allows limiting a too-significant increase in a storage space in memory to store the auxiliary artificial neural network.

In an advantageous embodiment, the auxiliary artificial neural network includes at least one binary quantized layer. The weights of the at least one layer then take the value “o” or “1”. The auxiliary artificial neural network can nevertheless have some layers, in particular, an input layer and an output layer, quantized in 8 bits or floats. The layers, called hidden layers, located between the input layer and the output layer can then be binary quantized. A binary quantized auxiliary neural network for most of these layers can be obtained to identify (i.e., classify) an element in a physical signal. The publication “Binary Neural Networks: A Survey” by Haotong Qin et al., published on Mar. 31, 2020, describes methods allowing obtaining a binary quantized neural network.

In one embodiment, the input physical signal is an image.

According to another aspect, a computer program is provided including instructions which, when the program is executed by a computer, lead the latter to implement a reference artificial neural network or an auxiliary artificial neural network distinct from the reference artificial neural network to detect events or elements in physical signals received as input of this reference artificial neural network or this auxiliary neural network. The auxiliary artificial neural network being simplified relative to the reference artificial neural network, assess a probability of presence of the event or the element in the physical signal by the implementation of the reference artificial neural network or by the implementation of the auxiliary artificial neural network, in which the program is configured to implement the reference artificial neural network when the probability of presence of the event or the element is greater than a threshold, and wherein the auxiliary artificial neural network is implemented when the probability of presence of the event or the element is below the threshold.

According to another aspect, a microcontroller is proposed having a memory in which a program is stored, as previously described, and a processor configured to execute the program.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment microcontroller; and

FIG. 2 is a flow chart of an embodiment method for detecting events or elements.

### DETAILED DESCRIPTION OF ILLUSTRATIVE EMBODIMENTS

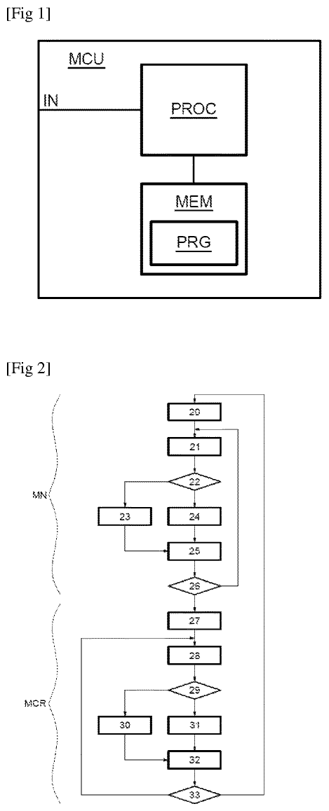

FIG. 1 illustrates an embodiment microcontroller MCU configured to be able to be supplied with energy by a battery (not represented). The microcontroller MCU is configured to implement a method for detecting events or elements in one physical signal or several physical signals. For example, the detection method can detect objects or people in images.

In embodiments, the physical signal is an image of a scene acquired by a camera. In another embodiment, the physical signal can originate from any other type of sensor. For example, the physical signal can be an audio signal delivered by a microphone or a signal delivered by an accelerometer, a gyroscope, a magnetometer, or a time of flight sensor.

The microcontroller MCU includes an input IN configured to receive the physical signal.

In embodiments, the microcontroller MCU includes a non-volatile memory MEM. In embodiments, the non-volatile memory MEM is a flash memory. The non-volatile memory stores a program PRG. Artificial neural networks execute the program PRG to detect events or elements in the physical signal received as input IN.

In embodiments, the microcontroller MCU includes a processor PROC configured to execute the program PRG and the artificial neural networks.

In embodiments, the PRG program is executed by a reference artificial neural network or an auxiliary neural network.

In embodiments, the detection method includes two modes of operation. In a first mode, called nominal mode, the reference artificial neural network is executed by the microcontroller MCU from the program PRG.

In a second mode, called low power mode, the auxiliary artificial neural network is executed by the microcontroller MCU from the program PRG. As will be described in the following, the low power mode is implemented when the probability of the presence of the event or the element determined following the execution of the reference artificial neural network is high. The nominal mode is implemented when the probability of the presence of the event or element determined following the execution of the auxiliary artificial neural network is low.

In embodiments, each neural network (e.g., the reference artificial neural network or the auxiliary artificial neural network) is adapted to take as input the physical signal in which events or elements can occur. For example, each neural network can take images as input. Each neural network is configured to generate detection data as output.

In embodiments, the auxiliary artificial neural network is distinct from the reference artificial neural network. In particular, the auxiliary artificial neural network can have a different topology from the reference artificial neural network.

In embodiments, the auxiliary artificial neural network can have weights that are different from the weights of the reference artificial neural network.

In embodiments, the auxiliary artificial neural network is designed from the reference artificial neural network by removing some neurons from the reference artificial neural network.

The auxiliary artificial neural network is a network that is simpler and faster than the reference artificial neural network. Thus the execution of the auxiliary artificial neural network consumes less energy than the execution of the reference artificial neural network.

The execution of the auxiliary artificial neural network in the low power mode reduces the energy consumption for detecting an event or element in the physical signal when the probability of the event or the element being determined is low.

Moreover, the auxiliary artificial neural network may be slightly less efficient than the reference artificial neural network. However, the reduced performance of the auxiliary artificial neural network is compensated by the implementation of the reference artificial neural network when the probability of the presence of the event or element determined by the auxiliary artificial neural network is high. In embodiments, the auxiliary artificial neural network is implemented only when the probability of presence is low.

In embodiments, the reference artificial neural network and the auxiliary artificial neural network can perform the same detection task. For example, the reference artificial neural network and the auxiliary artificial neural network are configured to be able to delimit the event or the element to be detected in the physical signal that they receive as input.

In embodiments, when the input physical signal is an image and an attempt is made to detect objects in this physical signal, the reference artificial neural network or the auxiliary artificial neural network can be adapted to frame this object in the image.

In embodiments, the reference artificial neural network and the auxiliary artificial neural network can perform different tasks. The reference artificial neural network can be configured to be able to delimit the event or the element to be detected in the physical signal and the auxiliary artificial neural network can be configured to be able only to identify (i.e., classify) a presence of the event or the element to be detected in the physical signal. For example, the auxiliary artificial neural network can be trained to define weights suitable for identifying an element or an event in a physical signal rather than locating this element or event in the physical signal. Such an auxiliary neural network can be simpler than a neural network capable of delimiting an event or an element to be detected in a physical signal. Such an auxiliary neural network can consume little energy and can be executed more quickly. The auxiliary artificial neural network also has the advantage of occupying a reduced space in the memory (RAM or ROM) relative to the reference artificial neural network. The auxiliary artificial neural network can be trained to define weights suitable for recognizing an element or an event in a physical signal rather than locating this element or this event in the physical signal.

The reference artificial neural network can be quantized on 8 bits to be accurate and have good performance. The auxiliary artificial neural network is, in turn, quantized to at most 8 bits. Preferably, the auxiliary artificial neural network is quantized on less than 8 bits. This allows limiting a too-significant increase in storage space in the memory MEM to store the auxiliary artificial neural network.

It is advantageous to quantify the hidden layers between an input layer and an output layer of the auxiliary artificial neural network in binary. The weights of these hidden layers then take the value “o” or “1”. The auxiliary artificial neural network can nevertheless have some layers, in particular, the input layer and the output layer, quantized in 8 bits or floats. A binary quantized auxiliary neural network for most of these layers can be obtained to identify an element in a physical signal. The publication “Binary Neural Networks: A Survey” by Haotong Qin et al., published on Mar. 31, 2020, and incorporated herein by reference in its entirety, describes methods allowing for obtaining a binary quantized neural network.

FIG. 2 illustrates a state diagram representing a method for detecting events or elements which can be implemented by the microcontroller.

In embodiments, the detection method includes executing either the reference artificial neural network or the auxiliary artificial neural network depending on the probability of the presence of an event or an element in the physical signal received at the input IN of the microcontroller MCU.

In embodiments, the method includes executing the reference artificial neural network when the microcontroller MCU implements the nominal mode of the detection method (i.e., when the probability of the presence of an event or an element is high).

In embodiments, the method includes executing the auxiliary artificial neural network when the microcontroller MCU implements the low power mode of the detection method (i.e., when the probability of the presence of an event or an element is low).

In embodiments, the reference artificial neural network is executed in the nominal mode MN in the upper portion of the diagram, and the auxiliary artificial neural network is executed in the low power mode MCR in the lower portion of the diagram.

The probability of the presence of an event or an element is assessed from a number of detections obtained over a given period by the reference artificial neural network or by the auxiliary artificial neural network.

In particular, the microcontroller uses a buffer memory Sb[ ] to count the number of events or elements detected over a period T1 in the nominal mode and over a period T2 in the low power mode. The periods T1 and T2 can be the same.

The method first includes an implementation of the nominal mode for steps 20 to 26.

In particular, the method includes step 20 for initializing the nominal mode in which the buffer Sb[ ] is reinitialized by setting the values Sb[0] to Sb[T1−1] to 0.

Then, the method includes step 21 of executing the reference artificial neural network. The reference artificial neural network is then executed by taking as input a physical signal, for example, an image. The execution of the reference artificial neural network allows detecting, in step 22, the presence or the absence of the event or the element in the physical input signal.

In embodiments, the artificial neural network can detect the presence of the event or element by delimiting this event or this element in the physical signal. If the reference artificial neural network detects a presence of the event or the element in the physical signal for an iteration i of the reference artificial neural network's execution, then the buffer Sb[i] value is set to 1 in step 23. If the reference artificial neural network detects an absence of the event or the element in the physical signal for an iteration i of the execution of the reference artificial neural network, then the value of the buffer Sb[i] is set to 0 in step 24. Then, the value of index i is incremented in step 25 following step 23 or 24.

At step 26, the microcontroller checks that the buffer is full. If the buffer is not full, then steps 21 to 25 are repeated to fill the buffer at the end of period T1. When the buffer is full, the microcontroller is configured to compare in step 26, the average value of the values of the buffer Sb[ ] with a threshold K1 defined between 0 and 1. If this average value is greater than the threshold K1, then the probability that the event or the element is indeed present is high; the artificial neural network then continues to be executed according to the nominal mode over a new period T1. Steps 21 to 26 are therefore reiterated as long as the average value of the values of the buffer at the end of a period T1 is greater than the threshold K1.

If the average value of the values of the buffer at the end of a period T1 is less than the threshold K1, then the method subsequently includes an implementation of the low power mode for steps 28 to 33 to reduce the energy consumption of the microcontroller while maintaining monitoring of the physical signal.

In particular, the method includes step 27 of initializing the low power mode in which the buffer Sb[ ] is reinitialized by setting the values Sb[0] to Sb[T2−1] to 0.

Then, the method includes step 28 of executing the auxiliary artificial neural network. The microcontroller MCU executes the auxiliary artificial neural network by taking the physical signal as input. The execution of the auxiliary artificial neural network allows detecting, at step 29, the presence or the absence of the event or element in the physical input signal. The execution by the auxiliary artificial neural network consumes less energy than the execution of the reference artificial neural network.

More particularly, as previously seen, the auxiliary artificial neural network can be a neural network capable of detecting an event or an element in the physical signal by delimiting this event or this element in the physical signal. Alternatively, the auxiliary artificial neural network may be a neural network capable of detecting an event or element in the physical signal by identifying this event or this element in the physical signal.

[owl] If the auxiliary artificial neural network detects the presence of the event in the physical signal for an iteration i of the execution of the auxiliary artificial neural network, then the value of the buffer Sb[i] is set to 1 in step 30. If the auxiliary artificial neural network detects an absence of the event or the element in the physical signal for an iteration i, then the value of the buffer Sb[i] is set to 0 in step 31. Then, the value of the index i is incremented in step 32 following step 30 or 31.

At step 33, the microcontroller checks that the buffer is full. If the buffer is not full, then steps 28 to 32 are repeated so as to fill the buffer at the end of the period T2. When the buffer is full, the microcontroller is configured to compare, also in step 33, the average value of the values of the buffer Sb[ ] with a threshold K2 defined between 0 and 1. If this average value is less than the threshold K2, then the probability that the event or the element is indeed present is low, the auxiliary artificial neural network then continues to be executed in the low power mode over a new period T2. Steps 28 to 33 are therefore reiterated as long as the average value of the values of the buffer at the end of a period T2 is below the threshold K2.

If the average value of the values of the buffer at the end of the period T2 is greater than the threshold K2, then the reference artificial neural network is executed in the nominal mode, by reiterating the method from step 20, so as to improve the detection of events or elements in the physical signal.

Advantageously, in the case where the auxiliary artificial neural network is only capable of identifying an event or an element in the physical signal, the identification allows simplifying the detection of the event or the element by the auxiliary artificial neural network relative to the reference artificial neural network. Once the event or element is identified in the physical signal, the reference artificial neural network can be implemented to delimit the event or the element. In this manner, the method allows for maintaining good performance.

For example, when the physical signal is an image and an attempt is made to detect an object or a person in the image, the auxiliary artificial neural network is configured to identify that an object or a person is present in the image, and the reference artificial neural network is configured to delimit the object or the person in the image, in particular to perform a tracking of this object or this person in a succession of images.

If the detection method is implemented for an application that is not too demanding in terms of location or tracking, it is preferable to use an auxiliary neural network allowing delimiting the event or the element in the physical signal.

Conversely, if the tracking or location requirements are high, it is preferable to use an auxiliary neural network allowing the identification (i.e., classifying) of the event or the element in the physical signal. Indeed, the identification of the event or the element in the physical signal is faster than a delimitation of this event or this element in the signal. Thus, the identification of the event or the element in the physical signal allows a faster switch to the nominal mode, and therefore allows better tracking of the event or the element in the physical signal.

The thresholds K1 and K2 can be adjusted according to the application for which the method is implemented. In particular, the thresholds K1 and K2 are selected depending on sensitivity (“recall”) or the desired accuracy. Nevertheless, it is advantageous to have a threshold K1 greater than a false alarm threshold defined for the reference artificial neural network to avoid detecting events or elements absent from the physical signal that prevent switching to the low power mode. Furthermore, when the auxiliary artificial neural network is configured to identify the presence of an event or an element in the physical signal, it is advantageous that the threshold K2 is greater than a false alarm threshold defined for this auxiliary neural network.

Furthermore, the threshold K1 can be adapted depending on the detections obtained by the implementation of the auxiliary artificial neural network following a switch to the low power mode MCR, and the threshold K2 can be adapted depending on the detections obtained by the implementation of the auxiliary artificial neural network following a switch to nominal mode MN. This allows for reducing the mode changes, which may be unnecessary between the nominal mode and the low power mode.

In particular, the threshold K2 used in the low power mode can be increased if the average value of the values of the buffer Sb[ ] obtained by the implementation of the reference artificial neural network is less than K1 following a switch to the nominal mode. The threshold K2 used in the low power mode can be lowered if the average value of the values of the buffer Sb[ ] obtained by the implementation of the reference artificial neural network is greater than K1 following a switch to the nominal mode. It may then be advantageous to define a lower and upper bound for the values that the threshold K2 can take.

Similarly, the threshold K1 used in the nominal mode can be increased if the average value of the values of the buffer Sb[ ] obtained by the implementation of the auxiliary artificial neural network is less than K2 following a switch to the low power mode. The threshold K1 used in the nominal mode can be lowered if the average value of the values of the buffer Sb[ ] obtained by the implementation of the auxiliary artificial neural network is greater than K2 following a switch to the low power mode. It may also then be advantageous to define a lower bound and an upper bound for the values that the threshold K1 can take.

It is also possible to adjust the periods T1 and T2 depending on the time of the day, in particular, if the presence of events or elements at certain moments of the day is a priori more likely than at other moments of the day. The periods T1 and T2 can also be adjusted according to the battery's remaining capacity powering the microcontroller or the darkness around the camera when the physical signal is an image. The periods T1 and T2 can also be adjusted from statistics calculated from the frequency of the detections obtained by implementing the detection method in the environment in which the physical signal is captured.

Moreover, when the physical signals received as input of the artificial neural network corresponding to a series of images generated by a camera, it is possible to reduce the number of images per second generated by the camera when the artificial neural network is executed according to the low power mode also to reduce the energy consumption required by the use of the camera.

Of course, the method described is not limited to the described embodiments. In particular, it is possible to change the detection method described above such that if the artificial neural network in the low power mode detects several events or elements in the same input physical signal (in particular, several objects in the same image), then the artificial neural network is then directly executed according to the nominal mode without waiting for the end of the period T2. Indeed, the detection of several events or elements in the same input physical signal (e.g., the same image) increases the probability of a real presence of at least one event or at least one element in this input physical signal.

Furthermore, to assess the relevance of switching to the low power mode or the nominal mode, it is also possible to rely on a level of confidence that can be delivered by the reference artificial neural network or by the network of auxiliary neurons at each performed detection. The probability of the presence of the event or the element can then be adapted depending on the level of confidence delivered for the detections obtained by the implementation of the reference artificial neural network or by the implementation of the auxiliary artificial neural network. In particular, the buffer Sb[ ] can be used to store confidence levels associated with each detection of an event or an element by the implementation of the reference artificial neural network or the auxiliary artificial neural network. It is then possible to compare an average value of the values stored in the buffer Sb[ ] with a given threshold to evaluate the probability of the presence of the event or the element in the physical signal before choosing whether it is preferable to switch from nominal mode to the low power mode, or vice versa.

Furthermore, in the above description, the artificial neural network is implemented by a microcontroller. Nevertheless, it is also possible to provide other computer systems which can implement the artificial neural network.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method, comprising:
determining, by an artificial neural network, a probability of a presence of an event or an element in a physical signal at an input of the artificial neural network;
executing the artificial neural network by a reference artificial neural network in response to the probability of the presence of the event or the element being greater than a threshold; and
executing the artificial neural network by an auxiliary artificial neural network in response to the probability of the presence of the event or the element being less than the threshold, the auxiliary artificial neural network being a distinct and simplified artificial neural network relative to the reference artificial neural network.

2. The method of claim 1, further comprising delimiting the event or the element by the reference artificial neural network or the auxiliary artificial neural network.

3. The method of claim 1, further comprising:
delimiting the event or the element by the reference artificial neural network; and
identifying the presence of the event or the element in the physical signal by the auxiliary artificial neural network.

4. The method of claim 1, wherein the threshold is defined based on a desired sensitivity of the artificial neural network.

5. The method of claim 1, wherein the threshold is defined based on a desired accuracy of the artificial neural network.

6. The method of claim 1, wherein the auxiliary artificial neural network comprises a binary quantized layer.

7. The method of claim 1, wherein the physical signal is an image of a scene acquired by a camera, an audio signal delivered by a microphone, or a signal delivered by an accelerometer, a gyroscope, a magnetometer, or a time of flight sensor.

8. A non-transitory computer-readable media storing computer instructions, that when executed by a processor, cause the processor to:
determine, by an artificial neural network, a probability of a presence of an event or an element in a physical signal at an input of the artificial neural network;
execute the artificial neural network by a reference artificial neural network in response to the probability of the presence of the event or the element being greater than the threshold; and
execute the artificial neural network by an auxiliary artificial neural network in response to the probability of the presence of the event or the element being less than a threshold, the auxiliary artificial neural network being a distinct and simplified artificial neural network relative to the reference artificial neural network.

9. The non-transitory computer-readable media of claim 8, further comprising delimiting the event or the element by the reference artificial neural network or the auxiliary artificial neural network.

10. The non-transitory computer-readable media of claim 8, further comprising:
delimiting the event or the element by the reference artificial neural network; and
identifying the presence of the event or the element in the physical signal by the auxiliary artificial neural network.

11. The non-transitory computer-readable media of claim 8, wherein the threshold is defined based on a desired sensitivity of the artificial neural network.

12. The non-transitory computer-readable media of claim 8, wherein the threshold is defined based on a desired accuracy of the artificial neural network.

13. The non-transitory computer-readable media of claim 8, wherein the auxiliary artificial neural network comprises a binary quantized layer.

14. The non-transitory computer-readable media of claim 8, wherein the physical signal is an image of a scene acquired by a camera, an audio signal delivered by a microphone, or a signal delivered by an accelerometer, a gyroscope, a magnetometer, or a time of flight sensor.

15. A microcontroller, comprising:
a non-transitory memory storage comprising instructions; and
a processor in communication with the non-transitory memory storage, the execution of the instructions by the processor cause the processor to:
determine, by an artificial neural network, a probability of a presence of an event or an element in a physical signal at an input of the artificial neural network;
execute the artificial neural network by a reference artificial neural network in response to the probability of the presence of the event or the element being greater than a threshold; and
execute the artificial neural network by an auxiliary artificial neural network in response to the probability of the presence of the event or the element being less than the threshold, the auxiliary artificial neural network being a distinct and simplified artificial neural network relative to the reference artificial neural network.

16. The microcontroller of claim 15, further comprising:
delimiting the event or the element by the reference artificial neural network; and
identifying the presence of the event or the element in the physical signal by the auxiliary artificial neural network.

17. The microcontroller of claim 15, wherein the threshold is defined based on a desired sensitivity of the artificial neural network.

18. The microcontroller of claim 15, wherein the threshold is defined based on a desired accuracy of the artificial neural network.

19. The microcontroller of claim 15, wherein the auxiliary artificial neural network comprises a binary quantized layer.

20. The microcontroller of claim 15, wherein the physical signal is an image of a scene acquired by a camera, an audio signal delivered by a microphone, or a signal delivered by an accelerometer, a gyroscope, a magnetometer, or a time of flight sensor.
